(19) United States
(12) Patent Application Publication
(10) Pub. No.: US 2016/0275360 A1
(43) Pub. Date: Sep. 22, 2016

(54) VEHICLE AND METHOD FOR CONTROLLING THE SAME

(71) Applicant: HYUNDAI MOTOR COMPANY, Seoul (KR)

(72) Inventors: Kyunghyun KANG, Suwon-si (KR); Ki Dong KANG, Seoul (KR); HeeJin RO, Seoul (KR); Seok-young YOUN, Seoul (KR); Sung Un KIM, Yongin-si (KR); Bitna BAEK, Seoul (KR); Ga Hee KIM, Suwon-si (KR); Jong Hyuck HEO, Yongin-si (KR); Chisung KIM, Seoul (KR)

(21) Appl. No.: 14/957,473

(22) Filed: Dec. 2, 2015

(30) Foreign Application Priority Data
Mar. 19, 2015 (KR) 10-2015-0038390

(51) Int. Cl. G06K 9/00; G06K 9/20; H04N 7/18; G08G 1/14; B60R 1/00

(52) U.S. Cl. CPC G06K 9/00812; G08G 1/143; B60R 1/00; H04N 7/181; G06K 9/209; B60R 2300/806

(57) ABSTRACT

A vehicle providing an available parking space, includes a communicator configured to receive parking information, which includes at least one of image information collected by at least one external device located within a threshold from the vehicle, and information about a location of the external device from the external device. A display is configured to display information about the available parking space, which is extracted from the parking information received from the communicator.

### CROSS-REFERENCE TO RELATED APPLICATION(S)

This application claims under 35 U.S.C. §119(a) of the benefit of priority to Korean patent application filed on Mar. 19, 2015 in the Korean Intellectual Property Office and assigned Serial No. 10-2015-0038390, the entire disclosure of which is incorporated hereby incorporated by reference.

### TECHNICAL FIELD

The present disclosure relates to a vehicle and a method for controlling the same, and more particularly, to a vehicle and a method for controlling the same, which receives surrounding parking information from an external device.

### BACKGROUND

Recently, a parking management system has been used in a large parking lot to help a driver parking more conveniently. The parking management system provides information on the number of available parking spaces on each floor. However, if the parking lot is too large in size, the driver may not find a parking space based on information about the number of available parking spaces, and needs to spend extra time to fine the parking space.

Accordingly, a system and a method for guiding a vehicle to a parking space using a mobile device such as a smartphone have been introduced.

### SUMMARY

An aspect of the present inventive concept provides a vehicle for receiving parking information from an external device through Device-to-Device (D2D) communication and method for controlling the same.

According to an embodiment of the present inventive concept, a vehicle providing an available parking space includes a communicator configured to receive parking information, which includes at least one of image information collected by at least one external device located within a threshold to the vehicle, and information about a location of the at least one external device from the at least one external device. A display is configured to display information about the available parking space, which is extracted from the parking information received from the communicator.

The vehicle may further include an image processor configured to image the parking information.

The vehicle may further include a controller configured to extract the information regarding the available parking space from the parking information received from the communicator.

The vehicle and the at least one external device may perform Device to Device (D2D) communication.

The at least one external device may be authenticated in advance.

The at least one external device may include an image capturer.

The at least one external device may include at least one of a surrounding vehicle and a closed circuit television (CCTV) located within the threshold the vehicle.

The communicator may simultaneously or sequentially receive parking information from the at least one external device when there are a plurality of external devices within the threshold from the vehicle.

The communicator may receive the parking information from the at least one external device via a server.

When a plurality of vehicles access the at least one external device, the parking information received from the server may include priority information for the plurality of vehicles.

The communicator may include a beacon module for collecting information about a location of the at least one external device.

The display may display the image information of the available parking space, taking into account a size of the vehicle.

The vehicle may further include a position detector for detecting information about locations of the vehicle and the at least one external device.

The position detector may include a Global Positioning System (GPS) module for creating GPS positioning information for the vehicle and the at least one external device.

In accordance with another exemplary embodiment of the present inventive concept, a method for controlling a vehicle providing an available parking space includes receiving, by a communicator, parking information from at least one external device located within a threshold from the vehicle; and displaying, by a display, information about available parking space, which is extracted from the received parking information.

The step of receiving the parking information from the external device may include receiving at least one of image information collected by the at least one external device and information about a location of the at least one external device.

The method may further include imaging the received parking information prior to the step of displaying.

The information may further include extracting the information regarding the available parking space from the received parking information.

The step of receiving the parking information from the at least one external device may include simultaneously or sequentially receiving the parking information from the external device if there are a plurality of external devices within a threshold from the vehicle.

The step of receiving the parking information from the at least one external device may include receiving the parking information from the at least one external device via a server.

The step of receiving the parking information from the at least one external device may include receiving the priority information for a plurality of vehicles when the plurality of vehicles access the at least one external device.

The step of displaying the information regarding the available parking space may include displaying the image information of the available parking space, taking into account a size of the vehicle.

The method may further include creating GPS positioning information for the vehicle and at least one external device located within the threshold from the vehicle.

Other aspects, advantages, and salient features of the disclosure will become apparent to those skilled in the art from the following detailed description, which, taken in conjunction with the annexed drawings, discloses exemplary embodiments.

### BRIEF DESCRIPTION OF THE DRAWINGS

The above and other features and advantages of the present disclosure will become more apparent by describing in detail exemplary embodiments thereof with reference to the attached drawings.

FIG. 1 shows an exterior of a vehicle according to an embodiment of the present inventive concept.

FIG. 2 shows an interior of a vehicle according to an embodiment of the present inventive concept

FIG. 3 shows an inside of an autonomous driving vehicle according to an embodiment of the present inventive concept.

FIG. 4 shows an inside of an autonomous driving vehicle according to another embodiment of the present inventive concept.

FIG. 5 shows an example of Device-to-Device (D2D) communication between a vehicle and an external device according to an embodiment of the present disclosure;

FIGS. 6 and 7 are control block diagrams of a vehicle for providing an available parking according to an embodiment of the present inventive concept.

FIGS. 8 to 11 show examples of parking information displayed on a display of a vehicle.

FIG. 12 shows an example of D2D communication between a vehicle and a plurality of external devices according to an embodiment of the present inventive concept.

FIG. 13 shows an example of a vehicle communicating with an external device via a server according to an embodiment of the present inventive concept.

FIG. 14 is a flowchart illustrating a method for controlling a vehicle according to an embodiment of the present inventive concept.

Throughout the drawings, like reference numerals will be understood to refer to like parts, components, and structures.

### DETAILED DESCRIPTION

A vehicle for receiving parking information and a method for controlling the same according to embodiments of the present inventive concept will now be described with reference to accompanying drawings.

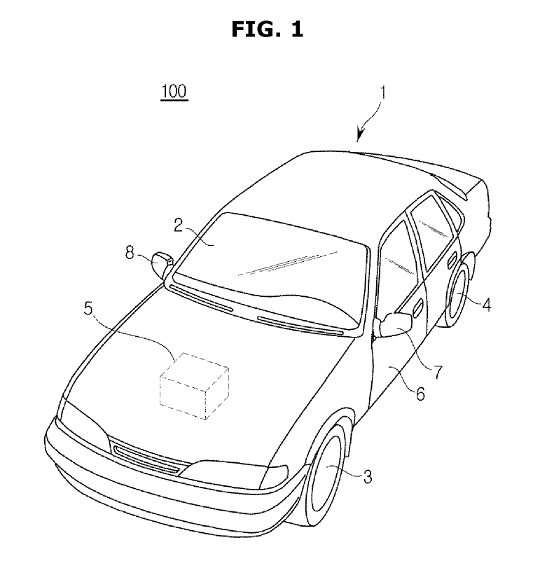

FIG. 1 shows an exterior of a vehicle according to an embodiment of the present inventive concept.

Referring to FIG. 1, a vehicle 100 may include a main body 1 that constitutes an exterior of the vehicle 100. A front glass 2 allows a driver inside the vehicle 100 to see a front view of the vehicle 100. Wheels 3, 4 move the vehicle 100, and a driving system 5 turns the wheels 3, 4. Doors 6 shield the inside of the vehicle 100 from outside. Side mirrors 7, 8 help the driver to see rear and side views of the vehicle 100.

The front shield 2 (or known as a windshield glass) is installed on a front side of the main body 100 for securing a front view for the driver inside the vehicle 100.

The wheels 3 and 4 include front wheels 3 and rear wheels 4, and the driving system 5 may provide a turning force to the front wheels 3 or rear wheels 4 to move the vehicle 100 forward or backward. The driving system 5 may employ a motor that produces the turning force from electrical power supplied from a storage battery (not shown) or a combustion engine (not shown) that burns a fuel to create the turning force.

The doors 6 may be pivotally attached onto left and right sides of the main body 1 for the driver and passenger to get on or get off the vehicle 100 and for shielding the inside of the vehicle 100. The doors 6 may have windows installed thereon for the driver and the passenger to look in or out through the windows. In some embodiments, the windows may be opened and closed having only one viewable side.

The side mirrors 7 and 8 include a left side mirror 7 and a right side mirror 8 mounted to the left and right sides of the main body 1, respectively, for helping the driver obtain views behind and to the side of the vehicle 100.

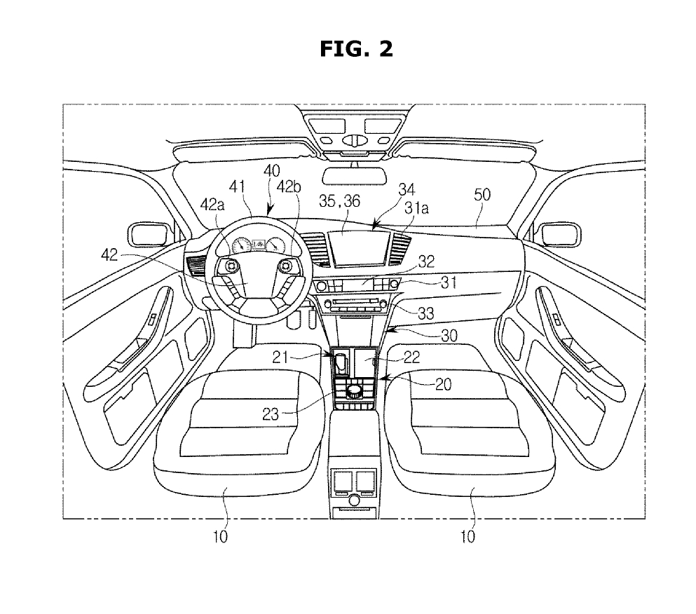

FIG. 2 shows an interior of the vehicle 100 according to an embodiment of the present inventive concept. Referring to FIG. 2, the vehicle 100 may include seats 10 for driver and passengers to sit on, a gear box 20, a center fascia 30, and a dashboard 50 having a steering wheel 40.

In the gear box 20, a gearshift 21 for shifting gears of the vehicle 100, and a touch pad 22 for controlling functions of the vehicle 100 may be installed. A dial adjuster 23 may be optionally installed.

In the center fascia 30, an air conditioner 31, a clock 32, an audio system 33, and an Audio Video and Navigation (AVN) system 34 may be installed.

The air conditioner 31 maintains the atmosphere inside the vehicle 100 pleasant by controlling temperature, humidity, air cleanness, and air flows inside the vehicle 100. The air conditioner 31 may include at least one vent 31a installed in the center fascia 30 for venting air. There may also be buttons or dials installed in the center fascia 30 to control, e.g., the air conditioner 31. The driver or a user may control the air conditioner 31 with the buttons arranged on the center fascia 30.

The clock 32 may be mounted around the buttons or dials for controlling the air conditioner 31.

The audio system 33 may include a control panel on which a number of buttons are mounted to perform functionality of the audio system 33. The audio system 33 may provide a radio mode for radio listening and a media mode for reproducing audio files stored in various storage media.

The AVN system 34 may be embedded in the center fascia 30 of the vehicle 100. The AVN system 34 comprehensively performs audio video and navigation functions of the vehicle 100 according to manipulation of the user. The AVN system 34 may include an input 35 for entering user commands regarding the AVN system 34, and a display 36 for displaying a screen related to audio play, video play, or navigation.

The steering wheel 40 controls a traveling direction of the vehicle 100 and includes a rim 41 to be held by the driver and a spoke 42 connected to a steering system of the vehicle 100 for connecting the rim 41 to a hub of a rotation shaft for steering. In the present disclosure, control devices 42a, 42b may be formed on the spoke 42 to control various devices, e.g., the audio system.

In the present disclosure, the dashboard 50 may further include various instrument panels to indicate traveling speeds of the vehicle 100, engine rpm, fuel gauge, or the like, and a glove box for containing things.

In addition to the aforementioned vehicle, the vehicle in accordance with the present disclosure may be installed in an autonomous driving vehicle. The autonomous driving vehicle is a vehicle that recognizes surrounding environments to determine traveling routes by itself while traveling, and that independently travels with its own power. The autonomous driving vehicle will now be described in more detail in connection with accompanying drawings.

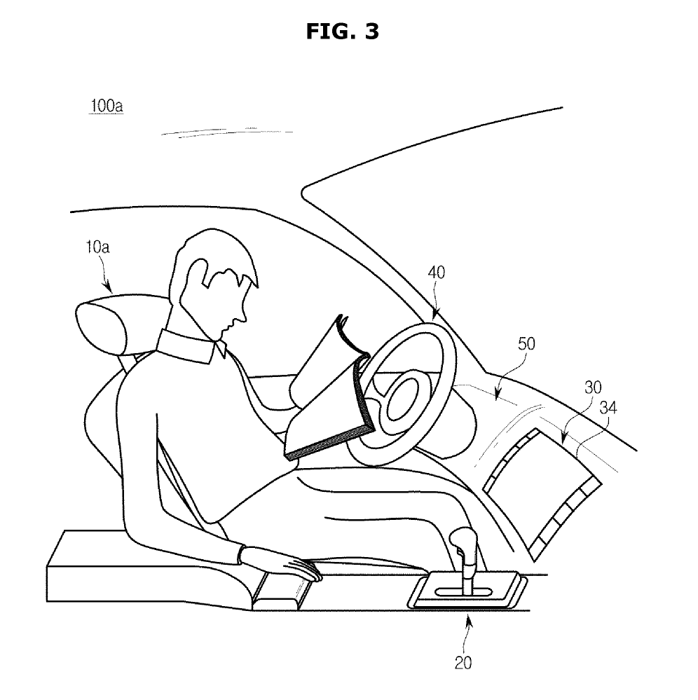

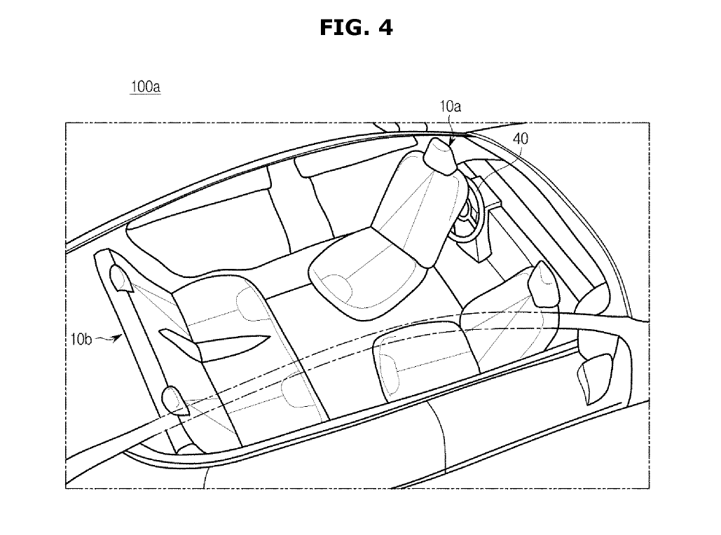

FIG. 3 shows an inside of an autonomous driving vehicle 100a according to an embodiment of the present inventive concept, and FIG. 4 shows an inside of the autonomous driving vehicle 100a, according to another embodiment of the present inventive concept.

The autonomous driving vehicle 100a of FIGS. 3 and 4 may include all the components shown in FIG. 1, but in some embodiments, may not include some of them, such as the gear box 20, steering wheel 40, etc.

Referring to FIGS. 3 and 4, the autonomous driving vehicle 100a may autonomously travel while the driver in the vehicle 100a is reading a newspaper or sleeping. A driver's seat 10a may be located to face the front of the vehicle 100a as shown in FIG. 3, or may face a back seat 10b as shown in FIG. 4.

The autonomous driving vehicle 100a may employ software technologies to analyze data collected through sensors and make quick and correct decisions on traveling of the vehicle 100a. Specifically, the autonomous driving vehicle 100a may employ various sensor technologies, mapping technologies, recognition/determination technologies, and communication technologies.

The sensor technology is to recognize surrounding environments with some instruments, such as multiple video cameras, a front monitoring infrared sensor, a radar, a Global Positioning System (GPS), a Lidar, a gyroscope, etc. The mapping technology is to estimate an absolute/relative position of the vehicle, and may represent a distance, a starting location, a destination, a road condition, etc., with coordinates of points and lines. The recognition/determination technology is to create a route to the destination and create a route for collision avoidance, and may determine how to react to other vehicles, traffic control systems, pedestrians, obstacles, or the like by combining data obtained from the sensors and comparing the combined data with stored mapping data. As a communication and control technology, a Device to Device (D2D) communication technology may be used as will be described below.

For convenience of explanation, the vehicle 100 of FIG. 1 will be taken as an example in the following embodiment of the present inventive concept.

The vehicle 100 may receive parking information from an external device. The vehicle 100 may receive parking information from a single external device or from a plurality of external devices. In some embodiments where a plurality of vehicles 100 make access to the external device, the vehicles 100 may receive parking information with priorities issued for the plurality of vehicles 100 from a server.

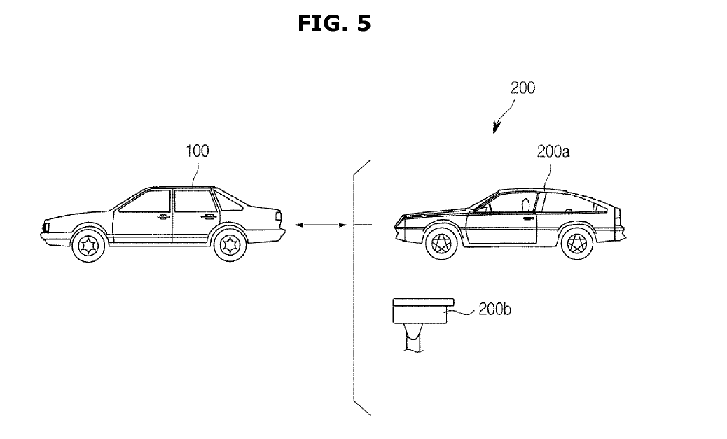

FIG. 5 shows an example of D2D communication between the vehicle 100 and a single external device 200 according to an embodiment of the present inventive concept.

Referring to FIG. 5, the vehicle 100 may communicate with the external device 200 located within a threshold from the vehicle 100 through D2D communication.

D2D communication refers to communication between devices to transmit and receive radio signals that contain various data including data detected by sensors and data stored in the devices. The D2D communication is one of Proximity Service (ProSe) supporting schemes, which may discover applications working in nearby devices and exchange related data through the applications. In other words, the D2D communication enables direct data exchanges among multiple devices without a separate network by setting up a direct link between the multiple devices.

The vehicle 100 may perform the D2D communication with the external device 200 located physically near to the vehicle 100, in which a fifth generation (5G) communication scheme may be applied. A 5G communication network may expand coverage of the D2D communication to enable communication between devices located farther from each other. In some embodiments, the vehicle 100 accesses the external device 200 in real time to receive parking information from the external device 200 while traveling, the details of which will be described below.

The external device 200 may be a nearby vehicle or Closed Circuit Television (CCTV) located within a threshold from the vehicle 100, but the external device 200 is not limited thereto but may be any device including an image capturing unit.

The external device 200 may be authenticated in advance. If the external device 200 is a vehicle and collects parking information from a surrounding vehicle 200a, privacy violation of the surrounding vehicle 200a may occur. If the external device 200 is a closed-circuit television (CCTV) and collects the parking information from a surrounding CCTV 200b, an the CCTV 200b may not provide images for a particular person and a problem of violation of privacy may arise. Accordingly, the external device that is authenticated in advance may be used herein.

An authentication scheme in accordance with an embodiment of the present inventive concept will be as follows. For example, when the external device 200 is a vehicle receiving parking information from surrounding vehicles, it provides the parking information to the surrounding vehicles. The external device 200 may thus be classified as, for example, the vehicle 200a is authenticated in accordance with the present disclosure. Furthermore, when the external device 200 is a CCTV providing parking information, it may be classified as, for example, the CCTV 200b that is authenticated in accordance with the embodiment of the present inventive concept. A method of authenticating a device is not limited to what is described above, but may be performed in other various ways.

For convenience of explanation, the external device 200 is the vehicle 200a. Hereinafter, the vehicle 100 requesting parking information will be referred to as a ‘parking vehicle 100’ and the vehicle 200a for providing parking information as an external device (e.g., 200a) will be referred to as a ‘surrounding vehicle 200a’.

The surrounding vehicle 200a may have an image capturer mounted on a front, back, or side of the surrounding vehicle 200a. The image capturer may include a black box of the vehicle 100. If the parking vehicle 100 requests parking information from the surrounding vehicle 200a, the surrounding vehicle 200a may collect surrounding parking information through the image capturer and send the collected parking information to the parking vehicle 100 via D2D communication. The parking vehicle 100 may receive the surrounding parking information from the surrounding vehicle 200a and may easily obtain the parking information using the received information. The parking information may include image information of available spaces for parking.

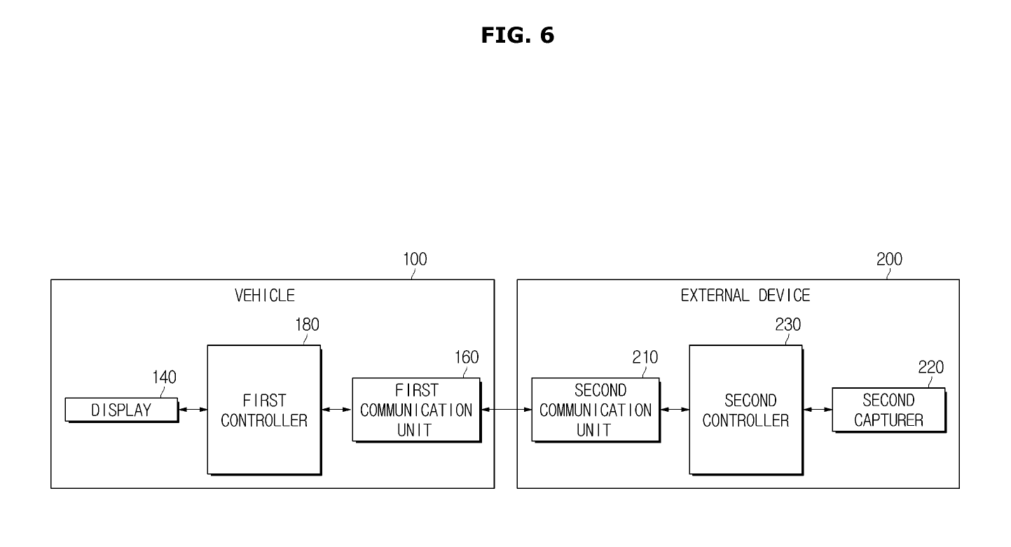

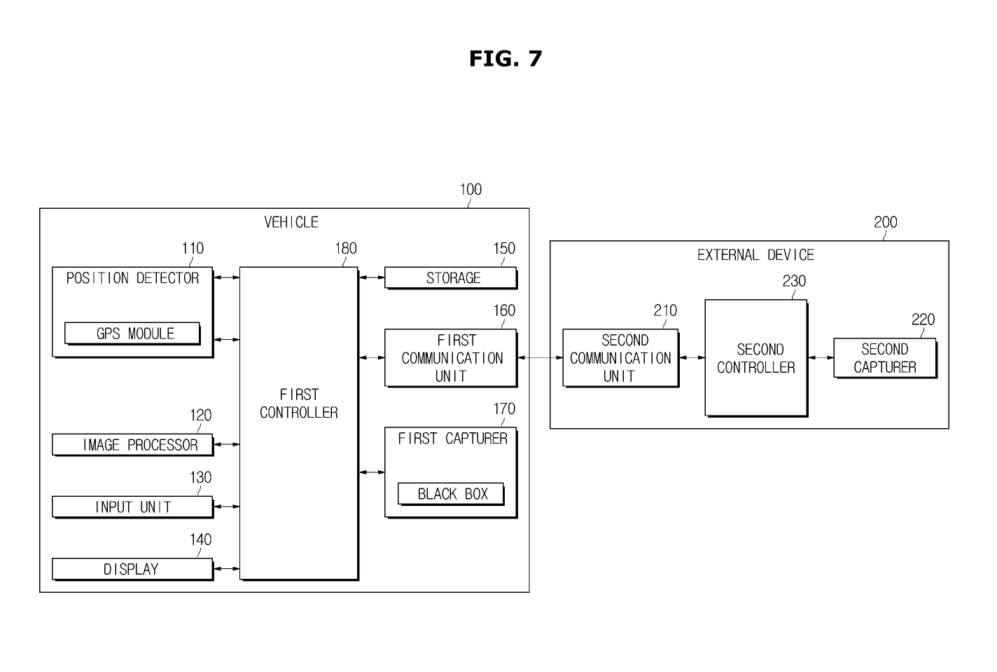

The vehicle 100 will now be described in more detail in connection with FIGS. 6 and 7. FIGS. 6 and 7 are control block diagrams of the vehicle 100 according to an embodiment of the present inventive concept.

Referring to FIGS. 6 and 7, the vehicle 100 may include a position detector 110, an image processor 120, a first input 130, a display 140, a storage 150, a first communicator 160, a first image capturer 170, and a first controller 180. The external device 200 may include a second communicator 210, a second image capturer 220, and a second controller 230.

The position detector 110 may include a GPS module for detecting current locations of the parking vehicle 100 and the external device 200 by receiving location data of the parking vehicle 100 and external device 200 transmitted from a GPS satellite. Specifically, the GPS module may generate GPS signals of a location of the parking vehicle 100 and at least one external device 200 located within a threshold from the parking vehicle 100, and detect GPS positioning information for the parking vehicle 100 and external device 200 from the generated GPS signals. In some embodiments, the GPS module may include a differential GPS (DGPS) module. The parking vehicle 100 may detect its location and a location of the external device 200 more correctly with the position detector 110 while discovering parking space in an outdoor parking lot, but the position detector 110 may be omitted in other embodiments.

The image processor 120 may process the parking information collected from the external device 200 and send the processing result to the first controller 180. The parking information collected from the external device 200 may include image information collected from the external device 200 and information about a location of the external device 200. Specifically, the image processor 120 may obtain the information about a location of the external device 200 in the process of handling the image information collected from the external device 200 and send the result to the first controller 180.

The image processor 120 may match a plurality of images collected from a plurality of external devices, and may output the matched image to the first controller 180. Furthermore, the image processor 120 may match other space than the available space for parking, and output the mosaic-processed image information to the first controller 180. In some embodiments, only information relating to violation of privacy of the external device 200, such as the driver and license plate of the external device 200 may be matched. If the parking information collected by the parking vehicle 100 or from the external device 200 is to be displayed on the first display 140 as it is, it may not go through further image processing.

The first input 130 receives control signals for various functions of the vehicle 100 from the user, and forwards the control signals to the first controller 180. The first input 130 may include an input 35 of the AVN system 34, which may be implemented in the form of a push button system or touch panel.

The first input 130 may receive control signals from the user to collect surrounding parking information, and forward the control signals to the first controller 180. In some embodiments, the first input 130 may also receive information about a radius within which to discover a surrounding external device 200 from the user.

The first display 140 may use light emitting diodes (LEDs) or a liquid crystal display (LCD), but is not limited thereto. The first display 140 may include the display 36 of the AVN system 34, but is not limited thereto. The first display 140 may be incorporated with the first input 130, or may be separated from the first input 130.

The first display 140 may display information about the external device 200 around the vehicle 100 and the parking information collected from the external device 200. The information about the external device 200 may include information about a location of the external device 200, and especially, within the threshold from the parking vehicle 100. Furthermore, the parking information may include information about an image of available space for parking considering a size of the parking vehicle 100.

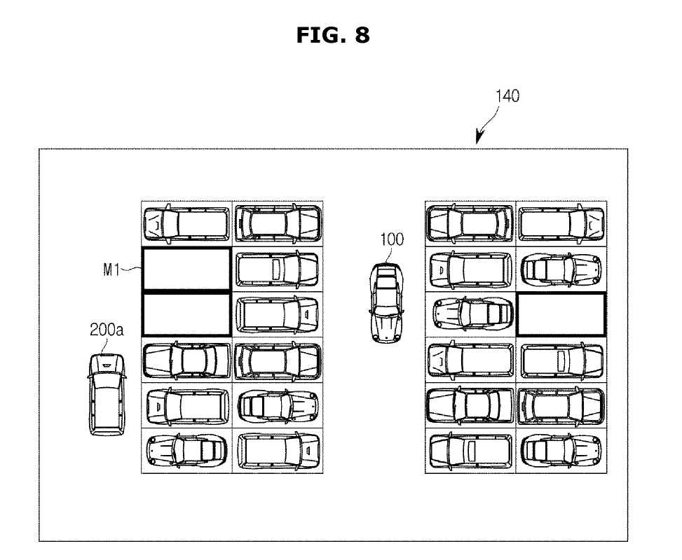

FIGS. 8 to 11 show examples of parking information displayed on the first display 140 of the vehicle 100.

As shown in FIG. 8, the parking information may be provided to display available space for parking with a particular mark M1. The parking information may represent a location of the parking vehicle 100 and a location of the surrounding vehicle 200a located within the threshold from the parking vehicle 100. In some embodiments, the information about the location of the surrounding vehicle 200a may be omitted.

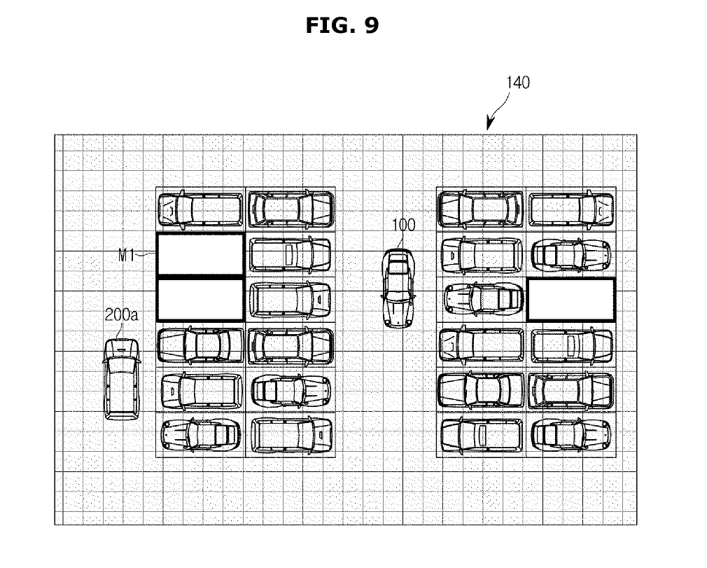

As shown in FIG. 9, the parking information may be provided to display an available space for parking with the particular mark M1 while performing a mosaic process on other space than the available space for parking. The parking information may represent a location of the parking vehicle 100 and a location of the surrounding vehicle 200a located within the threshold from the parking vehicle 100. In some embodiments, parts related to personal information of the external devices including the surrounding vehicle 200a, such as facial information of the drivers, license plate information, etc., may be mosaic-processed.

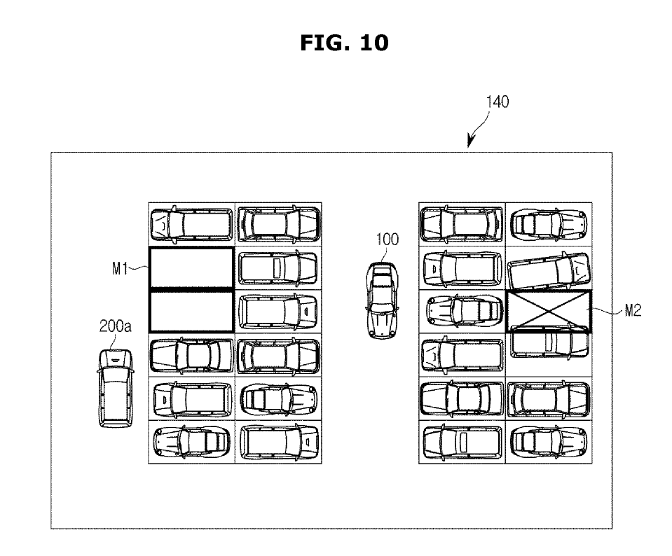

As shown in FIG. 10, the parking information may represent the available space for parking with the particular mark M1 and an unavailable space for parking with a mark M2 indicating that parking is not available in the unavailable space for parking, taking into account the size of the parking vehicle 100.

More specifically, if it is determined that the size of the available space for parking is narrower than the size of the parking vehicle 100 based on an image processing result of the image processor 120, the first display 140 may display the mark M2 to indicate that parking is unavailable in the corresponding parking space.

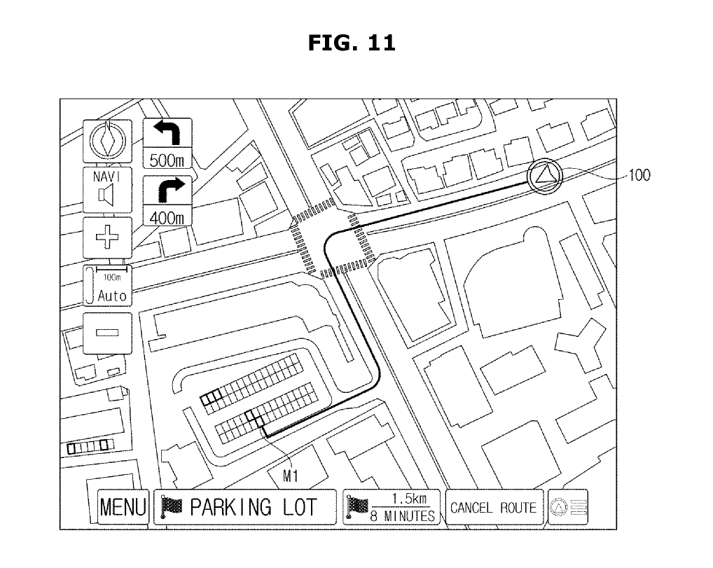

As shown in FIG. 11, the parking information may be provided to display an available space for parking (M1) on a navigation map stored in the parking vehicle 100, and information about a location of the available space for parking (M1) may also be displayed in some embodiments. More specifically, all the available space for parking around the parking vehicle may be displayed on the navigation map according to a reduced scale of the navigation map. For example, if the user selects a particular available space for parking, information about a location of the corresponding available space for parking may be displayed on the navigation map. Otherwise, if the particular available space for parking is not selected, information about a location of an available space for parking nearest to the parking vehicle 100 may be displayed on the navigation map.

The first display 140 may display parking information collected from the first image capturer 170 mounted on the parking vehicle 100 in addition to parking information collected from the external device 200, and the parking information collected from the external device 200 or the parking information collected by the parking vehicle 100 itself may be displayed in the form of an image or in a streaming form. The form of the parking information displayed on the first display 140 may vary depending on whether the collected information is image information or video information, or depending on settings of the user.

The storage 150 may store various data, programs, or applications for driving and controlling the vehicle 100. More specifically, a control program for controlling the vehicle 100, a dedicated application initially provided by a manufacturer or a universal application downloaded from outside, and/or the like may be stored in the storage 150. The storage 150 may store information about external devices 200 that perform short-range communication with the vehicle 100, parking information collected from the external devices 200, and navigation map information, and may temporarily store input/output signals.

The storage 150 may include at least one storage media of a flash memory, a hard disc, a memory card, a Read-Only Memory (ROM), a Random Access Memory (RAM), an Electrically Erasable Programmable ROM (EEPROM), a Programmable ROM (PROM), a magnetic memory, a magnetic disk, and an optical disc.

The first communicator 160 may perform D2D communication with the second communicator 210 of the external device 200. The first communicator 160 of the vehicle 100 may transmit/receive radio signals to/from the external device 200 via a base station in a communication scheme, such as 3G, 4G, etc. Furthermore, the first communicator 160 may transmit/receive radio signals including parking information to/from the external device 200 in a communication scheme, such as Wireless LAN, Wi-Fi, Bluetooth, Zigbee, Wi-Fi Direct (WFD), Ultra Wideband (UWB), Infrared Data Association (IrDA), Bluetooth Low Energy (BLE), Near Field Communication (NFC), etc.

Furthermore, the first communicator 160 may transmit/receive radio signals in a 5G communication scheme. The 4G communication scheme uses frequency band of about 2 GHz or less while the 5G communication scheme uses frequency band of about 28 GHz. However, the frequency band used by the 5G communication scheme is not limited thereto.

For the 5G communication scheme, a large-scale antenna system may be employed. The large-scale antenna system refers to a system that may cover even ultra-high frequency band and simultaneously transmit/receive a large amount of data through multiple accesses by using more than tens of antennas. Specifically, the large-scale antenna system may allow mass communication and expand the coverage of a 5G communication network, by adjusting arrays of antenna elements to transmit/receive radio waves farther away in a particular direction. Furthermore, the large-scale antenna system may help to improve transmission quality and to reduce the amount of power, by minimizing radio waves emitted in other directions than the direction in which the radio waves are transmitted to reduce noise.

The large-scale antenna system of 5G communication may be applied in the field of terminal networking. The terminal networking may employ a broadcast, unicast, or groupcast scheme, and the vehicle 100 in accordance with the present disclosure may perform networking in the groupcast scheme among the various schemes. More specifically, the groupcast scheme is to perform communication with the external device 200 that has been authenticated, increasing networking reliability and dealing with a problem of e.g., violation of privacy.

Furthermore, unlike existing schemes that modulate transmit signals in an Orthogonal Frequency Division Multiplexing (OFDM) scheme, the 5G communication scheme may transmit radio signals that are modulated in a Non-Orthogonal Multiplexing Access (NOMA) scheme, and may thus access more external devices 200 and enable simultaneous mass transmission/reception. Accordingly, the vehicle 100 may access a plurality of external devices 200 at the same time and share parking information collected by the external devices 200 with them.

The 5G communication scheme may also provide up to 1 Gbps of transfer rate, and accordingly, support immersive communication that requires mass transmission, such as Ultra-HD (UHD), 3D, hologram, etc. Accordingly, the vehicle 100 may receive parking information from the external device 200 regardless of whether the parking information collected by the external device 200 is ultra-high volume data.

The first communicator 160 may include a beacon module. The beacon module is a short-range wireless communication device based on a 4.0 (BLE) protocol, and may communicate with devices within up to 70 meters. In an embodiment, with the beacon module equipped in the first communicator 160, the vehicle 100 may obtain information about locations of surrounding external devices 200 from the external devices 200. In the embodiment, the external devices 200 are also assumed to have the beacon module, and the vehicle 100 may obtain information about locations of the external devices 200 by means of information about a location of the beacon module included in each of the external devices 200, and may forward the information about locations of the external devices 200 to the first controller 180.

The first image capturer 170 may collect parking information around the parking vehicle 100, and may include a black box mounted on the parking vehicle 100.

The first controller 180 may control general operation of the vehicle 100 and signal flows between the internal components of the vehicle 100, and process the data. The first controller 180 may run an operating system (OS) and various applications stored in the storage 150 at the user's request or when a predetermined condition is met.

When receiving a command to collect parking information from the user, the first controller 180 may control the position detector 110 to detect information about locations of the parking vehicle 100 and external device 200. Controlling the information about the location of the external device 200 to be detected may include controlling information about a location of at least one external device 200 located within the threshold from the vehicle 100 to be detected.

The first controller 180 may control the first communicator 160 to request parking information from the external device 200 based on the information about the location. The first communicator 160 may request parking information from the external device 200 and receive a response to the request for parking information from the external device 200.

When the response to the request for parking information is received from the external device 200, the first controller 180 may receive parking information from the external device 200 based on the response. The parking information may include video information or image information for the parking information collected from the second image capturer 220 of the external device 200.

Once the parking information is collected from the external device 200, the first controller 180 may forward the parking information to the image processor 120. The image processor 120 may process the parking information collected from the external device 200 and send the processing result to the first controller 180. In some embodiments where multiple pieces of the parking information are collected from a plurality of external devices, the multiple pieces of the parking information may be provided to the image processor 120.

The first controller 180 may control the image-processed parking information to be displayed on the first display 140. An image displayed on the first display 140 may be determined depending on the image processing results of the image processor 120, which will be described below in detail.

Features of the external device 200 will now be described.

The second communicator 210 may perform D2D communication with the first communicator 160 of the parking vehicle 100. The second communicator 210 may have the same features as those of the first communicator 160, so the description of what is overlapped with the first communicator 160 will be omitted herein.

The second image capturer 220 may collect parking information around the external device 200, and output the collected parking information to the second controller 230. If the external device 200 is a vehicle, the second image capturer 220 may include a black box, and if the external device 200 is a CCTV, the second image capturer 220 may be a camera embedded in the CCTV.

The second controller 230 may control general operation of the external device 200 and signal flows between the internal components of the external device 200, and process the data. When receiving a command to request parking information from the parking vehicle 100 through the second communicator 210, the second controller 230 may control the second communicator 210 to transmit the parking information collected by the second image capturer 220 to the parking vehicle 100.

D2D communication between the vehicle 100 and an external device 200 according to an embodiment of the present disclosure has been described. In the following description, D2D communication between the vehicle 100 and a plurality of external devices 200 according to an embodiment of the present inventive concept will be described.

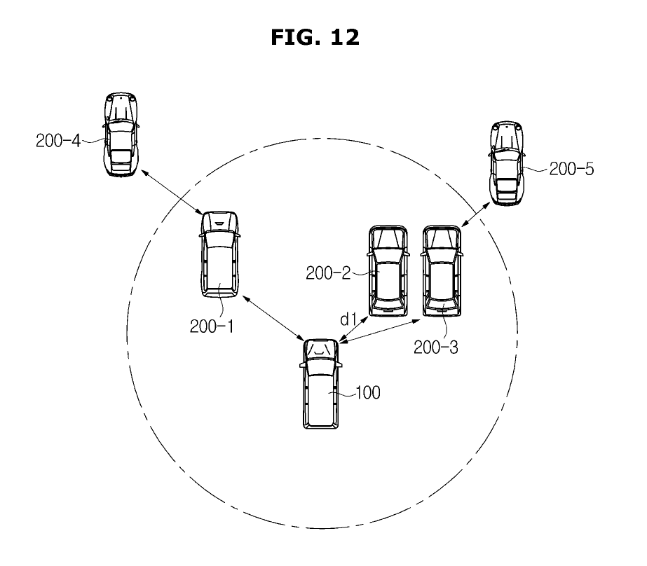

FIG. 12 shows a D2D communication scheme between the vehicle 100 and a plurality of external devices 200-1, 200-2, 200-3, according to an embodiment of the present inventive concept.

Referring to FIG. 12, the vehicle 100 may perform D2D communication with the plurality of external devices 200-1, 200-2, 200-3 located around the vehicle 100. The plurality of external devices 200-1, 200-2, 200-3 may be located within the threshold from the vehicle 100 and may be authenticated in advance. Description that overlaps with what are described in connection with FIG. 5 will be omitted herein and will focus on differences with FIG. 5.

When the parking vehicle 100 enters space like a parking lot, it may receive parking information from the external devices 200-1, 200-2, 200-3 located within the threshold from the parking vehicle 100. The parking vehicle 100 may receive the parking information from the external devices 200-1, 200-2, 200-3 in a 5G communication scheme that enables, by nature, simultaneous or sequential reception of the parking information from the external devices 200-1, 200-2, 200-3.

The parking information may be image information collected through image capturers of the external devices 200-1, 200-2, 200-3, and in some embodiments, the parking information may be information about locations of the external devices 200-1, 200-2, 200-3 received from beacon modules of the external devices 200-1, 200-2, 200-3.

When receiving multiple pieces of image information from the external devices 200-1, 200-2, 200-3, the parking vehicle 100 may match them to determine a location of available space for parking in the parking lot. In some embodiments, GPS information collected by the position detector 110 of the parking vehicle 100, or information about locations of the external devices 200-1, 200-2, 200-3 collected by a beacon module of the first communicator 160 may also be used.

Communication between the vehicle 100 and the external devices 200-1, 200-2, 200-3 may employ a multi-hop scheme for expansion of coverage. For example, if the vehicle 100 is connected to the first device 200-1, which is connected to a second device 200-4, the vehicle 100 may obtain parking information from the second device 200-4 via the first device 200-1. Accordingly, the vehicle 100 may obtain parking information not only from the external devices 200-1, 200-2, 200-3 around the vehicle 100 but also from external devices 200-4, 200-5 located farther away.

D2D communication between the vehicle 100 and a plurality of external devices 200-1, 200-2, 200-3 has thus far been described. Next, a communication scheme according to an embodiment of the present disclosure, in which a vehicle communicates with a plurality of devices via a server will be described.

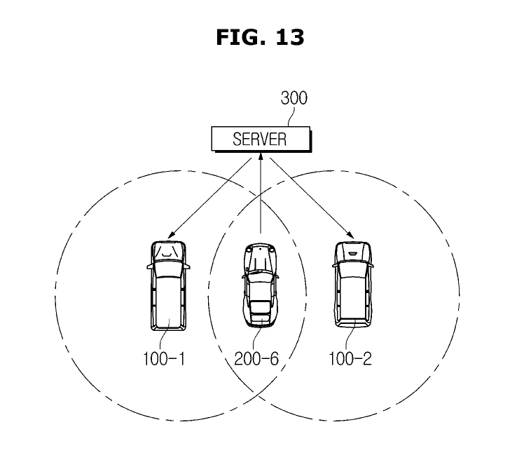

FIG. 13 shows a vehicle 100-1 communicating with an external device 200-6 via a server 300, according to an embodiment of the present inventive concept.

In some cases, a couple of vehicles 100-1, 100-2 may request parking information from an external device 200-6 at the same time, or sequentially at a short interval. In these cases, parking information with priorities issued in any method may be provided to the parking vehicles 100-1, 100-2. It is because, if the external device 200-6 may provide the same available space for parking to the respective parking vehicles 100-1, 100-2 that request parking information at the same time, one of the parking vehicles 100-1, 100-2 bothers to rediscover another available space for parking.

Accordingly, in this case, the server 300 may be involved in addition to the D2D communication between the vehicle 100-1 and the external device 200-6. The server 300 may provide parking information with priorities issued for the plurality of parking vehicles 100-1, 100-2 to the plurality of parking vehicles 100-1, 100-2 that are accessing the external device 200-6 at the same time.

For example, if the two parking vehicles 100-1, 100-2 request parking information from the single external device 200-6 while making access to the external device 200-6, the external device 200-6 may provide access information for the external device 200-6 to the server 300. The server 300 may provide parking information first to one of the two parking vehicles 100-1, 100-2 that made access first, based on the received access information. In some embodiments where the two parking vehicles 100-1, 100-2 access the external device 200-6 at the same time, parking information may be provided first to a vehicle according to a predetermined algorithm.

The vehicle 100 in accordance with an embodiment has thus far been described. In the following description, a method for controlling the vehicle 100 will be described.

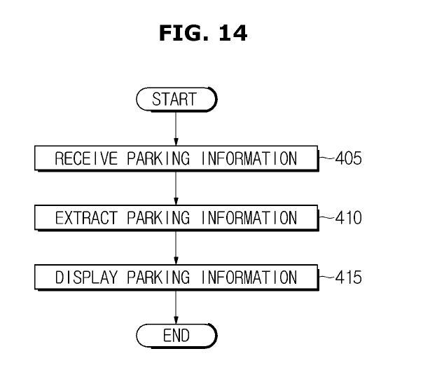

FIG. 14 is a flowchart illustrating a method for controlling the vehicle 100, according to an embodiment of the present inventive concept.

Referring to FIG. 14, a method for controlling the vehicle 100 includes receiving parking information, extracting information regarding available space for parking from the received parking information, and displaying the extracted information.

In some embodiments, the method may further include creating information about locations of the vehicle 100 and external device 200 around the vehicle 100, before the operation of receiving parking information. Creating information about locations of the vehicle 100 and external device 200 around the vehicle 100 may include creating GPS signals of at least one external device 200 located within the threshold from the parking vehicle 100 and a location of the parking vehicle 100, and detecting GPS positioning information from the GPS signals. This operation may be performed after the operation of receiving parking information.

Next, parking information may be received from the external device 200. The operation of receiving the parking information from the external device 200 may include at least one of receiving image information collected by the external device 200 and receiving information about a location of the external device 200.

More specifically, the external device 200 may send image information collected by the external device 200 to the parking vehicle in a D2D communication scheme at a request of the parking vehicle 100. In other embodiments, the external device 200 may send information about a location of the external device 200 to the parking vehicle 100 in a D2D communication scheme. The operation of sending the information about a location of the external device 200 may include sending information about a location of a beacon sensor equipped in the second communicator 210 of the external device 200.

Next, information regarding available space for parking may be extracted from the received parking information.

More specifically, extracting information regarding available space for parking from the received parking information may include performing image processing on the image information received from the external device 200. When there are a plurality of external devices 200 around the parking vehicle 100, the parking vehicle 100 may simultaneously or sequentially receive image information from the plurality of external devices 200. Alternatively, the parking vehicle 100 may receive image information from an external device located farther away in a multi-hop scheme. Once multiple pieces of image information are collected, image processing that matches the multiple pieces of image information may be performed, and accordingly, information regarding an available space for parking may be extracted.

In some embodiments, the vehicle 100 may collect information of a beacon sensor included in each external device 200 from a plurality of external devices 200, and accordingly, information regarding the available space for parking may be extracted. For example, if information about locations of the external devices 200 is collected from the external devices 200, the vehicle 100 may determine relative positions from the respective external devices 200, and may extract information regarding the available space for parking using the relative position information and the aforementioned image information.

Next, the information regarding available space for parking extracted from the received parking information may be displayed.

In some embodiments, a number of parking vehicles request parking information from the external device 200 at the same time or sequentially at very short intervals. In this case, as described above, parking information with priorities issued in any method may be provided to the parking vehicles.

Accordingly, in this case, the server 300 may be involved to provide the parking information with priorities issued, to the parking vehicle 100. Description that overlaps what is described above is omitted herein.

A vehicle (e.g., 100, 100a, or 100b) and a method for controlling the same was described above.

The vehicle for receiving the parking information and the method for controlling the same according to an embodiment of the present inventive concept have the following effects.

First, the user may check an available space for parking without moving around the destination for parking, thereby gaining safety and convenience.

Furthermore, parking information may be provided to the vehicle without use of a separate parking management system or the like, thereby saving costs for providing the parking information.

Several embodiments have thus been described, but it will be understood that various modifications can be made without departing the scope of the present disclosure. Thus, it will be apparent to those ordinary skilled in the art that the disclosure is not limited to the embodiments described, but can encompass not only the appended claims but the equivalents.

What is claimed is:

1. A vehicle providing an available parking space, the vehicle comprising:
a communicator configured to receive parking information, which includes at least one of image information collected by at least one external device located within a threshold from the vehicle, and information about a location of the at least one external device from the at least one external device; and
a display configured to display information about the available parking space, the information extracted from the parking information received from the communicator.

2. The vehicle of claim 1, further comprising: an image processor configured to image the parking information.

3. The vehicle of claim 2, further comprising: a controller configured to extract information regarding the available parking space from the parking information received from the communicator.

4. The vehicle of claim 1, wherein the vehicle and the at least one external device communicates with each other through Device to Device (D2D) communication.

5. The vehicle of claim 1, wherein the at least one external device is authenticated in advance.

6. The vehicle of claim 1, wherein the at least one external device comprises an image capturer.

7. The vehicle of claim 1, wherein the at least one external device comprises at least one of a surrounding vehicle and a closed circuit television (CCTV) located within the threshold from the vehicle.

8. The vehicle of claim 1, wherein the communicator is configured to simultaneously or sequentially receive the parking information from the at least one external device when there are a plurality of external devices within the threshold.

9. The vehicle of claim 1, wherein the communicator is configured to receive the parking information from the at least one external device via a server.

10. The vehicle of claim 9, wherein the parking information received from the server includes priority information for a plurality of vehicles when the plurality of vehicles access the at least one external device.

11. The vehicle of claim 1, wherein the communicator includes a beacon module for collecting the information about the location of the at least one external device.

12. The vehicle of claim 1, wherein the display is configured to display the image information of the available parking space, taking into account a size of the vehicle.

13. The vehicle of claim 1, further comprising:
a position detector configured to detect information about locations of the vehicle and the at least one external device.

14. The vehicle of claim 13, wherein the position detector includes a global positioning system (GPS) for creating GPS positioning information for the vehicle and the at least one external device.

15. A method for controlling a vehicle providing an available parking space, the method comprising:
receiving, by a communicator, parking information, which includes at least one of image information collected by at least one external device located within a threshold from the vehicle, and information about a location of the at least one external device from the at least one external device; and
displaying, by a display, information about the available parking space, which is extracted from the received parking information.

16. The method of claim 15, further comprising:
imaging the received parking information before the step of displaying.

17. The method of claim 15, further comprising:
extracting the information regarding the available parking space from the received parking information.

18. The method of claim 15, wherein the step of receiving the parking information from the external device comprises:
simultaneously or sequentially receiving the parking information from the external device when there are a plurality of external devices within the threshold from the vehicle.

19. The method of claim 15, wherein the step of receiving the parking information from the external device comprises:
receiving the parking information from the at least one external device via a server.

20. The method of claim 19, wherein the step of receiving the parking information from the external device comprises:
receiving priority information for a plurality of vehicles via the server when the plurality of vehicles access the external device.

21. The method of claim 15, wherein the step of displaying the information regarding the available parking space comprises:
displaying the image information of the available parking space, taking into account a size of the vehicle.

22. The method of claim 15, further comprising:
creating GPS positioning information for the vehicle and at least one external device located within the threshold from the vehicle.
